(19) United States
(12) Patent Application Publication
(10) Pub. No.: US 2016/0301526 A1
(43) Pub. Date: Oct. 13, 2016

(54) SYSTEM FOR SHARING A CRYPTOGRAPHIC KEY

(71) Applicant: KONINKLIJKE PHILIPS N.V., Eindhoven (NL)

(72) Inventors: RONALD RIETMAN, EINDHOVEN (NL); OSCAR GARCIA-MORCHON, AACHEN (DE); LUDOVICUS MARINUS GERARDUS MARIA TOLHUIZEN, WAALRE (NL); SANTOS MERINO DEL POZO, SANTANDER (ES)

(21) Appl. No.: 15/037,697

(22) PCT Filed: Nov. 18, 2014
(86) PCT No.: PCT/EP2014/074841

§ 371 Date: May 19, 2016

(30) Foreign Application Priority Data
Nov. 21, 2013 (EP) 13193839.1

(51) Int. Cl. H04L 9/08

(52) U.S. Cl. CPC H04L 9/085; H04L 9/083; H04L 9/0866

(57) ABSTRACT

A system (200) for configuring a network device (300) for sharing a key, the shared key being • bits long, the system comprising:—a key material obtainer (210) for—obtaining in electronic form a first private set of bivariate polynomials (252, \check{z}_{″}(,)), and a second private set of reduction integers (254, f_{″}), with each bivariate polynomial in the first set there is associated a reduction integer of the second set, and a public global reduction integer (256, . . . ) associated with the second private set of reduction integers (254, f),—a network device manager (230) for obtaining in electronic form an identity number (310, ¥) for the network device, the identity number being • bits long, wherein •>•, and—a polynomial manipulation unit (220) for computing for the network device a univariate private key polynomial (229) from the first and second private sets by—obtaining a set of univariate polynomials by—for each particular polynomial of the first private set, substituting the identity number (¥) into said particular polynomial \check{z}_{″}(¥,) and reducing modulo the reduction integer associated with said particular polynomial, and—summing the set of univariate polynomials,—the network device manager being further configured for electronically storing the generated univariate private key polynomial (229, 236) and the public global reduction integer (256, . . . ) at the network device.

### FIELD OF THE INVENTION

The invention relates to a system for configuring a network device for key sharing, the system comprising: a key material obtainer for obtaining a polynomial, a network device manager for obtaining in electronic form an identity number for the network device, and a polynomial manipulation unit.

### BACKGROUND

In cryptography, a key-agreement protocol is a protocol whereby two or more parties that may not yet share a common key can agree on such a key. Preferably, both parties can influence the outcome so that neither party can force the choice of key. An attacker who eavesdrops on all communication between the two parties should learn nothing about the key. Yet, while the attacker who sees the same communication learns nothing or little, the parties themselves can derive a shared key.

Key agreement protocols are useful, e.g., to secure communication, e.g., to encrypt and/or authenticate messages between the parties.

Practical key agreements protocols were introduced in 1976 when Whitfield Diffie and Martin Hellman introduced the notion of public-key cryptography. They proposed a system for key agreement between two parties which makes use of the apparent difficulty of computing logarithms over a finite field GF(q) with q elements. Using the system, two users can agree on a symmetric key. The symmetric key may then be used for say, encrypted communication between the two parties.

The Diffie-Hellman system for key agreement is applicable when the parties do not yet have a shared secret. The Diffie-Hellman key agreement method requires resource-heavy mathematical operations, such as performing exponentiation operations over a finite field. Both the exponent and the field size may be large. This makes key agreement protocols less suitable for low-resource devices. On the other hand key agreement protocols would be very useful in resource-restrained devices. For example, in application areas such as the internet of things, ad-hoc wireless networks, and the like, key agreement could be used to protect links between devices. Another example is communication between a reader and an electronic tag, say a card reader and a smart card, or a tag reader and tag, e.g., an RFID tag or an NFC tag.

Another approach to the problem of setting up secure connections between pairs of network devices in a given communications network is given in C. Blundo, A. De Santis, A. Herzberg, S. Kutten, U. Vaccaro and M. Yung, •Perfectly-Secure Key distribution for Dynamic Conferences•, Springer Lecture Notes in Mathematics, Vol. 740, pp. 471-486, 1993 (referred to as , Blundo f).

This system assumes a central authority, also referred to as the network authority or as the Trusted Third Party (TTP), that generates a symmetric bivariate polynomial f(x,y), with coefficients in the finite field F with p elements, wherein p is a prime number or a power of a prime number. Each device has an identity number in F and is provided with local key material by the TTP. For a device with identifier ,,, the local key material is the coefficients of the polynomial f(,,,y). If a device wishes to communicate with device ,,f, it uses its key material to generate the key K(,,, ,,^{f})=f(,,, f). As f is symmetric, the same key is generated. The local key material is secret. Knowledge of the local key material would directly compromise the system. In particular it would allow an eavesdropper to obtain the same shared key. The method requires that each device in a network of devices has its own unique identity number and local key material.

A problem of this key sharing scheme occurs if an attacker knows the key material of t+1 or more devices, wherein t is the degree of the bivariate polynomial. The attacker can then reconstruct the polynomial f(x,y). At that moment the security of the system is completely broken. Given the identity numbers of any two devices, the attacker can reconstruct the key shared between this pair of devices.

A further concern in key sharing concerns the following. It may be hard to obtain the key material of many devices. It may be easier to obtain the shared key that a target device has shared. It may be assumed that a larger number of such shared keys may be available. For example, an attacker may collect the key that the target device used to communicate with a large group of devices which are at least partially under the attackerfs control. From the collection of shared keys, the attacker may attempt to predict the keys the target device would use when communication with devices that are not under the attackers control. This attack does not aim at the root key material used to generate the local key material in each device, but attacks the local key material of specific target device.

The paper •Towards fully collusion-resistant ID-based establishment of pairwise keys•, by Oscar Garcia-Morchon, et. al., discloses a key establishment scheme.

### SUMMARY OF THE INVENTION

It would be advantageous to have an improved system for key distribution and key sharing between network devices, especially low-resource network devices. It would be especially advantageous to have system for key sharing which is more resistant against attacks of the type described above.

A system for configuring a network device for sharing a key is provided wherein the shared key is bits long. The system comprises a key material obtainer, a network device manager and a polynomial manipulation unit.

The key material obtainer is configured to obtain in electronic form a first private set of bivariate polynomials, and a second private set of reduction integers, with each bivariate polynomial in the first set there is associated a reduction integer of the second set, and a public global reduction integer associated with the second private set of reduction integers.

The polynomial manipulation unit is configured to compute for the network device a univariate private key polynomial from the first and second private sets by obtaining a set of univariate polynomials by for each particular polynomial of the first private set, substituting an identity number into said particular polynomial and reducing modulo the reduction integer associated with said particular polynomial, and summing the set of univariate polynomials.

The network device manager is configured to obtain in electronic form the identity number for the network device, the identity number being bits long, wherein •>•. The network device manager is further configured to electronically store the generated univariate private key polynomial and the public global reduction integer at the network device.

The inventors found that using shared keys that are smaller than the identity numbers significantly increased the resilience against attacks wherein an attacker has access to the keys that a target device shared with controlled devices. The key that is shared in this fashion may be used as cryptographic key directly. However, the inventors further found that the storage resources may be reduced by combining multiple small shared keys in one larger shared key. Although storage resources increase to accommodate the multiple key materials this is less than the storage requirement that would be required by one monolithic key material, with a correspondingly larger size of the identity numbers. Using identifiers longer which are longer than the generated shared key makes the usage of lattice attack infeasible while allowing for scalability because of the longer identifier.

In an embodiment the network device is configured for sharing a combined key, the combined key being derived from multiple shared keys. The combined key is also referred to as a ,large key f derived from multiple shared ,small f keys. The words small and large do not indicate an absolute size but that the small keys are smaller in size that the large keys.

Combining many small keys in one large key does not reduce the strength of the resulting large key, while resilience against attacks is increased and the required increase in storage is modest. In an embodiment, the length of the combined key is at least B.

In an embodiment, the public global reduction integer has at least (,+1)•+•bits, wherein , is the highest degree in a single variable of the bivariate polynomials in the first private set. This size of the public global reduction integer increases the chance that two configured network devices will arrive at the same key, while at the same time reducing leakage in shared keys. Likewise, in an embodiment each private reduction integer satisfies f_{″}=. . . †‡_{″}2^{̂}, for some integer †_{″} with †_{″}<2^{‰}. When the differences between private reduction integers are smaller than a threshold (e.g. 2^{‰\check{S}̂}) and/or have a common multiple (e.g. 2^{̂}) the chance that two devices generate the same shared key is higher. In a preferred embodiment, the public global reduction integer has exactly (,+1)•+• bits.

In an embodiment, the key material obtainer is configured to obtain multiple first private sets of bivariate polynomials, with each bivariate polynomial in a first set of the multiple first sets there is associated a reduction integer of a second private set. The polynomial manipulation unit is configured to compute multiple univariate private key polynomials from the multiple first private sets, by for each first private set of the multiple private sets obtaining a set of univariate polynomials by for each particular polynomial of said first private set, substituting an identity number into said particular polynomial and reducing modulo a reduction integer of a second private set associated with said particular polynomial, and summing the set of univariate polynomials. The network device manager is further configured for electronically storing the multiple generated univariate private key polynomials at the network device.

Using a single instance to generate shared keys of sufficient length, would require quite large identity values. The identity values in turn may require the coefficient of the polynomials to be large. A sizeable reduction in storage is obtained by combining multiple smaller keys. This allows the size of the identity numbers to be smaller. For example, one may combine the smaller keys to obtain a larger keys of bit size B or larger.

In an embodiment, the key material obtainer is configured to obtain multiple second private sets of reduction integers. With each particular first set of the multiple first sets there is associated a particular second set of the multiple second sets. With each bivariate polynomial in a particular first set of the multiple first sets there is associated a reduction integer of the associated second set of the multiple second sets. The polynomial manipulation unit being configured for reducing modulo a reduction integer associated with said particular polynomial from a second set associated with said first set. An embodiment has one public global reduction integer per set. For example, public global reduction integer [symbol] , is associated with first set number <.

In an embodiment, the key material obtainer is configured to obtain in electronic form multiple public global reduction integers, with each first set of the multiple first sets there is associated a public global reduction integer of the multiple public global reduction integers, the network manager being further configured for electronically storing the multiple generated public global reduction integers at the network device.

The system is more secure if the identity numbers are distributed in a random manner across their B bits. There are a number of ways to improve this. For example, in an embodiment, the network device manager is configured to generate in electronic form the identity number for the network device, the identity number being • bits long, wherein •>•.

In an embodiment, at least part of the identity number is randomly generated. For example, the whole number may be randomly generated, or a pre-determined number of the, say most significant, bits.

In an embodiment, generating the identity number comprises hashing a further identity number and assigning the result of the hashing to at least part of the identity number. For example, network devices may be assigned a further identity number, such as a network address such as a MAC address, or a serial number. The suitability of such numbers may be increased by hashing them.

An aspect of the invention concerns a first network device configured to determine a shared key with a second network device, the shared key being • bits long. The first network device comprises an electronic storage, a communication unit and a polynomial manipulation unit. The electronic storage is configured to store a univariate private key polynomial and a public global reduction integer obtained from a system for configuring a network device for key sharing, the storage further storing a first identity number for the first network device used to generate the univariate private key polynomial, the first identity number being • bits long, wherein •>•.

The communication unit is configured to obtain a second identity number of the second network device, the second identity number being bits long, wherein •>•, the second network device being different from the first network device.

The polynomial manipulation unit is configured to substitute the second identity integer into the univariate private key polynomial, reducing the result of the substituting modulo the public global reduction integer, and further reducing the result of the reducing modulo the public global reduction integer modulo 2^{̂}. The device may comprise a key derivation unit for deriving the shared key from the result of the latter modulo reduction.

In an embodiment, the electronic storage is configured to store multiple univariate private key polynomials obtained from a system for configuring a network device for key sharing. The polynomial manipulation unit is configured to obtain multiple small shared keys from the multiple univariate private key polynomials, by for each univariate private key polynomial in the multiple univariate private key polynomials, substitute a second identity integer into the univariate private key polynomial, reduce the result of the substituting modulo a public global reduction integer, and further reducing the result of the reducing modulo the public global reduction integer modulo 2^{̂}. The device may further comprise a key derivation device for deriving the combined shared key from the multiple small shared keys.

In an embodiment, the electronic storage is configured to store multiple public global reduction integers, with each univariate private key polynomial of the multiple univariate private key polynomials there is associated a public global reduction integer of the multiple public global reduction integers. The polynomial manipulation unit is configured to reduce the result of the substituting modulo the public global reduction integer associated to the univariate private key polynomial.

In typical embodiments the further reduction modulo 2̂ is applied directly to the result of the reducing modulo the public global reduction integer. However, there may be additional steps after reducing the result of the substituting modulo the public global reduction integer but before the step of further reducing. For example, another way to increase security with multiple univariate private key polynomials is as follows. In an embodiment, the polynomial manipulation unit is configured to substitute the second identity integer into each univariate private key polynomial of the multiple univariate private key polynomials and reduce the result of the substituting modulo the public global reduction integer associated to the univariate private key polynomial. The polynomial manipulation unit is configured to sum the result of the reducing modulo the associated public global reduction integer. The latter sum is than reduced modulo 2^{̂}. The device may comprise a key derivation unit for deriving the shared key from the result of the latter modulo reduction.

These two uses of multiple univariate private key polynomials may be combined, by using multiple sets of multiple univariate private key polynomials, wherein the sets of multiple univariate private key polynomials are used to obtain a shared key, and the thus obtained shared keys are combined into a larger combined key.

In an embodiment, the electronic storage stores multiple identity numbers for the first network device. The communication unit is configured to obtain multiple identity numbers of the second network device, with each univariate private key polynomials of the multiple univariate private key polynomials there is associated an identity number of the multiple identity numbers. The polynomial manipulation unit is configured to obtain multiple small shared keys from the multiple univariate private key polynomials by for each univariate private key polynomial in the multiple univariate private key polynomials, generate a small shared key of size •_{″}, the key size being smaller than the size of the identity number associated with said univariate private key polynomial (•_{″}<•_{″}), substitute said identity integer into said univariate private key polynomial, reduce the result of the substituting modulo a public global reduction integer ( [symbol] ), and further reduce the result of the reducing modulo the public global reduction integer ( [symbol] ) modulo 2^{̂}œ.

In an embodiment, the first network device comprises a key equalizer configured to compute key confirmation data for a shared key and send the key confirmation data to the second network device. In an embodiment, the first network device comprises a key equalizer configured to receive key confirmation data from the second network device and to adapt a small key to conform to the received key confirmation data. Using a key equalizer it can be guaranteed that the same shared key is derived by the first and second device.

An aspect of the invention concerns a key sharing system comprising a system for configuring a network device for key sharing and a first and second network device configured by the system for configuring a network device for key sharing.

An aspect of the invention concerns a method for configuring a network device for key sharing. An aspect of the invention concerns a method for determining a shared key of size b with a second network device.

### BRIEF DESCRIPTION OF THE DRAWINGS

These and other aspects of the invention are apparent from and will be elucidated with reference to the embodiments described hereinafter. In the drawings,

FIG. 1 is a schematic block diagram of a system 200 for configuring a network device for key sharing and a first network device 300;

FIG. 2 is a schematic block diagram of a first network device 300 and a second network device 350;

FIG. 3a is a schematic block diagram of a key sharing system 100

FIG. 3b is a schematic block diagram of a key sharing system 102

FIG. 4 is schematic block diagram of an integrated circuit 400,

FIG. 5 is a flowchart illustrating a method 500 for configuring a network device for sharing a key of b bits long,

FIG. 6 is a flowchart illustrating a method 600 for determining a shared key of size b with a second network device 350.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION OF EMBODIMENTS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described.

Below an embodiment of the key sharing method is described in mathematical terms. The key sharing method may be implemented in devices as described below, e.g., on a system (200) for configuring a network device (300), in a key sharing system (100), (102) and the like.

In the embodiment below network devices are configured to obtain a shared key that has fewer bits than the identity numbers of the network devices. Such a shared key is referred to as a ,small key f. In a subsequent embodiment, a multiple of these small keys will be combined to obtain a larger key. We refer to the generation of one small key as an ,instance f. To generate larger keys, multiple instances are needed. The multiple instances may however share some of their parameters. Below first a single instance is described.

The method has a set-up phase and a use phase. The set-up phase may include initiation steps and registration steps. The initiation steps do not involve the network devices.

The initiation steps select system parameters. The initiation steps may be performed by the trusted third party (TTP). The system parameters may also be regarded as given inputs. In that case the trusted third party need not generate them, and the initiation steps may be skipped. For example, the trusted third party may receive the system parameters from a device manufacturer. The device manufacturer may have performed the initiation steps to obtain the system parameters. For convenience of exposition we will refer to the trusted third party as performing the initiation steps, bearing in mind that this is not necessary.

### Initiation Steps

The desired key length for the small key that will be shared between devices in the use phase of an instance is selected; this key length is referred to as ,•f. The desired identity number length is also selected. During the later registration steps each device will be associated with an identity number of identity number length; the identity number length is referred to as ,•f. The length of numbers are measured in bits.

It is a requirement that •<•. In an embodiment • is a multiple of •, say • is at least 2•, or for recommended security levels, • is at least 4•. A typical value for a low security application may be •=8,•=16. For high security •=8,•=32 is better. Higher security could use ••8 (e.g. •=8), and •\check{Z}128 (e.g. •=128).

With each instance the two parties can derive a shared key. The shared keys can be combined to form a larger combined key. The number of instances is chosen so that the combined key is long enough for the security application in which it will be used. For example, one option is to choose the number of instances as ••_{‘’″}/b″, in which •‘’″ is a desired key length, e.g., 80 bits or more, 128 bits or more, 256 or more, etc. It is preferred to make the combined key as least as large as the individual identity numbers, and choose the number of instances as ••/•″, or higher.

Smaller values of •with respect to• increase resilience to so-called collusion attacks. In a collusion attack, an attacker obtains information on the shared key used between a target network node and multiple colluding network nodes. The amount of information learned from each additional colluding network node is of size •. However, the amount of information that needs to be reconstructed in order to break commutation between the target network node and non-colluding network nodes grows with •.

Typically all instances will use the same •and•, although this is not necessary. Two instances could use different values for •and/or•, even if they are later combined in a single larger key.

Often the number of instances, the key size and the sub-key lengths will be pre-determined, e.g., by a system designer, and provided to the trusted party as inputs.

### Instance Parameters

Next the parameters for each instance are selected. The desired degree is selected; the degree controls the degree of certain polynomials. The degree will be referred to as ,, f, it is at least 1. A practical choice for , is 2. A more secure application may use a higher value of ,, say 3 or 4, or even higher. For a simple application also ,=1 is possible. The case ,=1 is related to the so called ,hidden number problem f; higher •,• values are related to the extended hidden number problem confirming that these cases are hard to break. The value ,=1, although possible, is not recommended, and should only be considered for very low security applications. For low security application a value of ,>2, say ,=3 is possible. However, for high security ,\check{Z}32 is recommended, say ,=32.

The number of polynomials is selected. The number of polynomials will be referred to as ,•f. A practical choice for • is 2. A more secure application may use a higher value of •, say 3 or 4, or even higher.

Note that a low-complexity application, say for resource bounded devices may use •=1. The value •=1, although possible, is not recommended, and should only be considered for low security applications. Higher values of security parameters , and • increase the complexity of the system and accordingly increase its intractability. More complicated systems are harder to analyze and thus more resistant to cryptanalysis. Below it is assumed that •\check{Z}2.

A public modulus . . . is selected satisfying 2^{(-\check{S}} [symbol] ^{‰\check{S}̂~—}•. . . . Preferably, public modulus . . . is chosen to have exactly (TM+1)•+• bits, and thus that also . . . <2^{(—\check{S}} [symbol] ^{‰\check{S}̂}. For example, . . . may be chosen at random in this interval. Often the key length •, degree , and number of polynomials • will be pre-determined, e.g., by a system designer and provided to the trusted party as inputs. The public modulus may also be fixed, say in a standard, but more typically will be selected during generation of the parameters.

A number of • private moduli f [symbol] f_{\check{s}}, . . . , f [symbol] are selected. Moduli are positive integers. Each selected number satisfies the following relationship f_{œ}=. . . † ‡_{œ}•2^{̂}. Wherein the ‡_{œ} are random •—bits integers, i.e., ‡_{œ}<2^{≯}, more preferably they have exactly B bits, i.e., 2^{‰}^{^{~}}−•‡_{œ}<2^{‰}.

For •>1, the system is more complicated, and thus more secure, since modulo operation for different moduli are combined even though such operations are not compatible in the usual mathematical sense. For this reason it is advantageous to choose the selected private moduli f_{œ} pairwise distinct.

A number of • bivariate polynomials [symbol] \check{z}_{\check{s}}, . . . , \check{z}, of degrees, œ are generated. Preferably, the bivariate polynomials are symmetric; this allows all network devices to agree on a shared key with each other network device. These bivariate polynomials may also be chosen asymmetric. All degrees satisfy , œ•, , and for at least one Ÿ, we have , œ=, . A better choice is to take each polynomial of degree™. A bivariate polynomial is a polynomial in two variables. A symmetric polynomial \check{z} satisfies \check{z}(,i)=\check{z}(i,). Each polynomial \check{z}_{œ}is evaluated in the finite ring formed by the integers modulo f_{œ} obtained by computing modulo f_{œ} The integers modulo f_{œ} form a finite ring with f_{œ} elements. The coefficients of polynomial \check{z}_{œ} are integers, and represent an element in the finite ring defined by modulo f_{œ} operations. In an embodiment the polynomial \check{z}_{œ} is represented with coefficients from 0 up to f_{œ}†1. The bivariate polynomials may be selected at random, e.g., by selecting random coefficients within these bounds.

The security of the key sharing depends on these bivariate polynomials as they are the root keying material of the system; so preferably strong measures are taken to protect them, e.g., control procedures, tamper-resistant devices, and the like. Preferably the selected integers f [symbol] f_{\check{s}}, . . . , f [symbol] are also kept secret, including the value ‡_{œ} corresponding to f_{œ} though this is less critical. We will refer to the bivariate polynomials also in the following form: for j=1, 2, . . . , m, we write \check{z}_{œ}(,i)=_{″}⁻£¤\check{Z}_{″,œ}( )i″.

The above embodiment can be varied in a number of ways. The restrictions on the public and private moduli may be chosen in a variety of ways, such that obfuscation of the univariate polynomial is possible, yet that the shared keys obtained at network devices remain sufficiently close to each other sufficiently often. What is sufficient will depend on the application, the required security level and the computing resources available at the network devices. The above embodiment combines positive integers such that the modular operations which are carried out when generating the polynomials shares are combined in a non-linear manner when they are added over the integers, creating a non-linear structure for the local key material stored on a network device. The above choice for . . . and f_{œ} has the property that: (i) the size of . . . is fixed for all network devices and linked to ,; (ii) the non-linear effect appears in the coefficients forming the key material stored on the device. Because of that specific form the shared small key may be generated by reducing modulo 2^{̂} after the reduction modulo . . . .

### Registration Steps

In the registration step each network device is assigned keying material (KM). The keying material comprises keying material for each instance. Below we describe how keying material for one instance is derived for a network device. Each instance has keying material that is unique to that instance, even though parts of the keying material may be shared among different instances.

A network device is associated with an identity number ¥. The identity number may be assigned on demand, e.g. by the TTP, or may already be stored in the device, e.g., stored in the device at manufacture, etc. The bit size of ¥ is • bits. Generating ¥ may be done in a variety of ways. For high security the low bits of ¥ are random. For example, ¥ may be selected as a random number; ¥ may be the hash of a further identity number, say a serial number, possibly truncated to • bits.

The TTP generates a set of keying material for a device A as follows:

$$\text{?} ( ″ ) = \text{?} < \text{?} ( , {Y}^{=} ) > \text{?} = \text{?}$$

$$\text{?} \text{indicates text missing or illegible when filed}$$

It possible to add further obfuscating numbers to this, as follows:

$$\text{?} ( ″ ) = \text{?} < \text{?} ( , {Y}^{=} ) > \text{?} + \text{?} = \text{?}$$

$$\text{?} \text{indicates text missing or illegible when filed}$$

Wherein •¦§(^{. .}) is the keying material of a device with identity number ¥; ^{..} is a formal variable. Note that the keying material is non-linear. The notation <®>a [symbol] denotes reducing modulo f_{¥} each coefficient of the polynomial between the brackets. Stated differently, we have that

$$\text{?} = \text{?} ( {Y}^{=} ) \text{?} + \text{?}$$

$$\text{?} \text{indicates text missing or illegible when filed}$$

The notation ,—_{§},,,f denotes a random integer, which is an example of an obfuscating number, such that |—_{§},,,|<2^{(2\check{s}} [symbol] ³⁾′. Note that any one of the random integers may be positive or negative. The random numbers — are generated again for each device. The term _{″£¤}^{μ-}_{§,,,}^{..}″ thus represents a polynomial in ^{..} of degree™, which the coefficient length is shorter with increasing degree. Alternatively, a more general, but more complicated condition is that _{″£¤}^{μ}|—§,,,|•2″^{̂} is small, e.g., <2^{μ\check{S}—}. The mixing effect over different finite rings provides the largest contribution to security, the use of obfuscating numbers is thus optional.

All other additions may either use the natural integer arithmetic, i.e., in the ring ¶, or (preferably) they use addition modulo . . . . So the evaluation of the univariate polynomials

$$\text{?} < \text{?} ( , {Y}^{=} ) > \text{?}$$

$$\text{?} \text{indicates text missing or illegible when filed}$$

is each individually done modulo a smaller modulus f_{œ} but the summation of these reduced univariate polynomials themselves is preferably done modulo . . . . Also adding the obfuscating polynomial 2^{̂}_{″£¤}^{μ}−_{§,,,}^{..}″ may be done using natural integer arithmetic or, preferably, modulo . . . . The keying material comprises the coefficients [symbol] with <=0, , ™. The keying material may be presented as a polynomial as above. In practice, the keying material may be stored as a list, e.g., an array, of the integers [symbol] . The device A also receives the numbers . . . and •. Manipulation of polynomials may be implemented, e.g., as manipulation of arrays containing the coefficients, e.g., listing all coefficient in a predetermined order. Note that polynomials may be implemented, in other data structures, e.g., as an associative array (also known as a ,map f) comprising a collection of (degree, coefficient) pairs, preferably such that each coefficient appears at most once in the collection. The coefficients [symbol] that are provided to the device are preferably in the range 0, 1, . . . , N−1.

### Use Phase

Once two devices have an identity number A and B and received the keying material for this instance from the TTP, they may use their keying material to obtain one small shared key. Device A may perform the following steps, for each instance, to obtain his shared key. First, device A obtains the identity number of device B, then A generates the shared key by computing the following:

*§‰=<<•¦§( ), £‰>1>\check{s}⁰=>>_{″} [symbol] _{″}§•″>1>\check{s}⁰

That is, A evaluates his keying material, seen as an integer polynomial, for the value B; the result of evaluating the keying material is an integer. Next device A reduces the result of the evaluation first modulo the public modulus . . . and then modulo the key modulus 2^{̂}. The result will be referred to as A fs shared key with B, it is an integer in the range of 0 up to 2̂†1. For its part, device B can generate B fs shared key with A by evaluating its keyed material for identity ¥ and reducing the result modulo . . . and then modulo 2^{̂}.

If the bivariate polynomials in the root key material are symmetric A fs shared key with B and B fs shared key with A are often, though not necessarily always, equal. The particular requirements on the integers f [symbol] f_{\check{s}}, . . . , f [symbol] , and on the random numbers ± are such that the keys are often equal and almost always close to each other modulo two to the power the key length. If A and B have obtained the same shared key, then they may use it as a symmetric key which is shared between A and B; for example, it may be used for a variety of cryptographic applications, for example, they may exchange one or more messages encrypted and/or or authenticated using the shared key. Preferably, a key derivation algorithm is applied to the shared key for further protection of the master key, e.g., a hash function may be applied.

Even if A and B have not obtained the same shared key, it is certain that these keys are close to each other, in the sense that •§‰=•‰§+¼ . . mod 2^{̂}; herein ¼ is a small number, at most 3•+2, in absolute value. Define ½=. . . ^{~—}mod 2^{̂}, i.e., the inverse of N modulo 2^{̂}. Then

<½•§‰>\check{s}^{0=<}½•‰§+¼>\check{s}⁰

Let c be the smallest number such that 2^{3/4}\check{Z}1+2(3•+2,), then A may send the [symbol] least significant bits of ½•§‰ as key confirmation data. This enables B to determine •§‰ from •‰§ and the key confirmation data.

The selected • private moduli, f [symbol] f_{\check{s}}, •,f [symbol] , are preferably pair wise relatively prime. If these numbers are pair wise relatively prime the lack of compatibility between the modulo operations is increased. Obtaining pair wise relatively prime numbers may be obtained by selecting the integers in order, testing for each new integer if all pairs of different numbers are still relatively prime, if not the just selected number is removed from the set. This procedure continues until all • numbers are selected. The complexity increases even further by requiring that the selected • private moduli, f [symbol] f_{\check{s}}, . . . , f, are distinct prime numbers.

### Combining Multiple Instances

The system described allows network nodes to agree on shared keys that are smaller than their identifiers. The combination of higher security and practical implementation makes it desirable to choose values of • that are relatively small, say •• 8 or possibly even ••16. Such choices of • are however too small for secure encrypted communication. This could be resolved by choosing a much larger value of •, for example, by selecting the identity number length • as 512 bits or more, and the key length • as 128 bit or more. In this case, a single instance would allow two network nodes to share a key of • bits, which is sufficiently long for secure communication. However, having •=512 makes the local key material correspondingly larger. It is thus possible, even using only moderately powerful network devices, say mobile phones, to configure the network device for securely sharing a key that is sufficiently long for secure communication, yet requiring only a single instance. Nevertheless it would be very desirable to reduce storage requirements while still deriving sufficiently long shared keys.

One way to increase key length without creating impractically long key material is to combine multiple small keys. The system allows the party to agree on multiple sub-keys which together form the shared key. We will refer to the system that generates a sub-key as a key-agreement instance. Each instance may have its own independent parameters, but operates along the same principles as the other instances. Nevertheless, the multiple instances may share some of their parameters. We will refer to a shared key obtained from a system as described above, i.e., from a single instance, as a , small f key, and the combination of two or more small keys as a , large keys f. The number of instances combined is referred to as ,Àf.

A first way to obtain multiple small keys is to select multiple fully independent instances. However, since security requirements for each of the small keys are equal, the multiple instance will typically have the same values for •,•,, , and •. The TTP generates a public modulus . . . , private moduli f_{″}, private polynomials \check{z}_{″} for each instance, and for each instance and each network node an identifier ¥ and local key material •¦^{§}.

A second way to combine multiple instances is to use for each instance the same identifier ¥ . A third way is to use for each instance the same public modulus . . . . Finally, one could use the same identifier ¥ and the same public modulus . . . . The local key material will not be the same for all instances.

For example, the size of the shared large key depends on the security requirements, it may be 64 or 80. A typical value for a consumer level security may be 128. Highly secret applications may prefer 256 or even higher values. In an embodiment the length of the combined key is equal to the length of the identifier •. Also the number of instances ,Àf and the sizes of the sub-keys are selected. The sizes of the sub keys in different instances may be different. We may refer to the size of a sub key in instance ,<f as ,•_{″}f. These are chosen so that •_{″}\check{Z}•. For simplicity we will drop the index, and denote the size of the sub-key below as ,•f. Typically, the size of the sub-keys will be equal in all instances, and chosen such that •À=•.

Each device uses the different instances of key material to generate sub-keys. The shared key is then generated from the sub-keys, e.g., by concatenating the sub-keys.

Amongst others, the following parameter set for B=32 has been experimentally verified to be more secure than others: alpha=10, b=8, B=32, this system requires 4 instances to make a 32 bit key. The parameter set alpha=3, b=8, B=32 is also secure, however with this lower choice of alpha, it is advisable to use the full span of 32 bits IDs. In particular, in any interval of length 256, less 10 IDs should be used. In general, more security is achieved by setting pre-determined first and second identity threshold and choosing identity numbers such that no interval of size of the first identity threshold (e.g. 256) contains more than the second identity threshold (e.g. 10) of identity values. This can be enforced for example, by the network device manager, e.g. by generating identify values according to this rule, or by refusing generation of local key material for devices having a identify value that exceeds the thresholds.

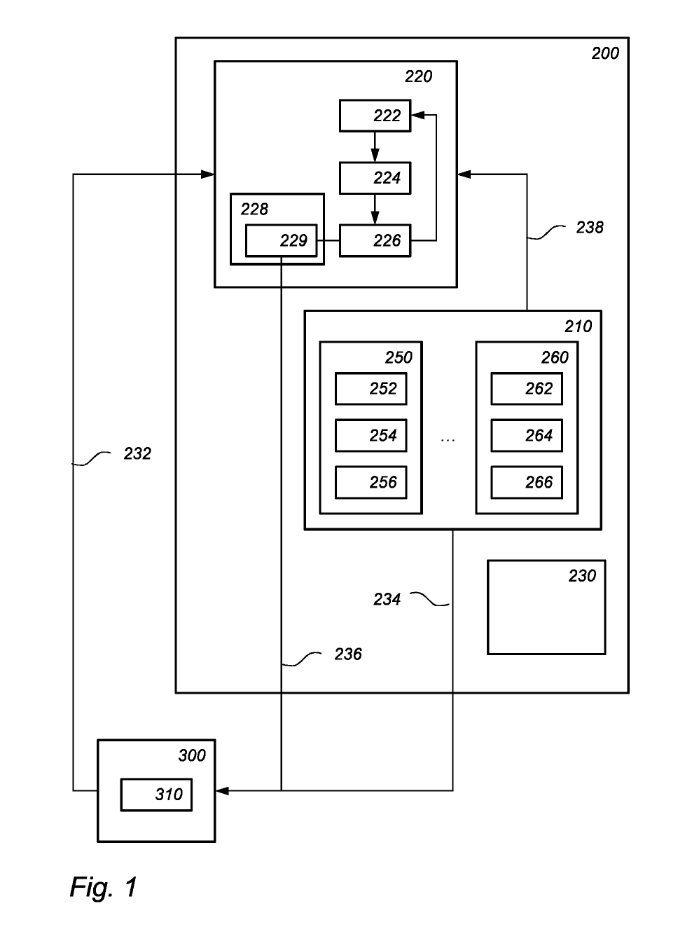

FIG. 1 is a schematic block diagram of a system 200 for configuring a network device for key sharing and a first network device 300.

System for configuring 200 is typically implemented as an integrated device. For example, system for configuring 200 may be comprised in a server. System for configuring 200 may configure network devices over a network, say a wireless network, or the internet, and the like. However, system for configuring 200 may also be integrated in a manufacturing device for manufacturing the network devices.

System for configuring 200 comprises a key material obtainer 210, a network device manager 230 and a polynomial manipulation unit 220. System for configuring 200 is intended to work with multiple network devices. FIG. 1 shows one such device, first network device 300.

System for configuring 200 selects secret key material, also referred to as root key material. System for configuring 200 then derives local key material for each of the multiple network devices. The local key material is derived from the root key material and at least one public identity number ¥ of the network device. In FIG. 1, network device 300 stores identity number 310. A network device may also have multiple identity numbers, e.g., one per instance. Network device may also store a further identity number and derive the identity number 310 therefrom when needed, e.g., by hashing the further identity number.

The local key material comprises parts that are private to a particular network device, i.e., only accessible to one particular network device and possibly trusted devices. The local key material may also contain parts that, though needed to obtain a shared key, are less critical to keep secret.

The use of the adjectives public and private, is intended as helpful for understanding: Even with access to all public data, the private data cannot be computed, at least not without unreasonable high resources given the security of the application or compared to the resources needed for key generation, encryption and decryption. However, ,public f does not mean that the corresponding data is necessarily made available to anybody else than system for configuring 200 and the network devices. In particular, keeping the public global reduction integer and other public parameters secret from untrusted parties increases security. Likewise, access to private data may be restricted to the party that generated or needs that data, this increases security. However, a trusted party may be allowed access to the private data; Access to private data reduces security.

Using their local key material and the identity number of the other party, the network devices can agree on a shared key between them.

Key material obtainer 210 is configured to obtain in electronic form at least a first parameter set 250. The first parameter set comprises a public global reduction integer 256, . . . , a first private set of bivariate polynomials 252, \check{z}_{″}(,), and a second private set of reduction integers 254, f_{″}, with each bivariate polynomial in the first set there is associated a reduction integer of the second set, and a public global reduction integer 256, . . . . The first parameter set is generated for network nodes having identifying number of bit-size •. The first parameter set, i.e. the first instance, will be used for generating local key material which in turn will be used to derive a shared small key. The bit-size of the small key • satisfies •<•. In this way the amount of information that can be learned from the shared key is smaller than the amount of information that needs to be reconstructed. This makes the corresponding lattice problem harder, and even intractable.

In preferred embodiments, the key material obtainer 210 is configured to obtain in electronic form multiple parameter sets 250, 260. FIG. 1 shows a first parameter set 250 and a second parameter set 260. The number of parameter sets is sometimes indicated as ,tf. There may be more than 2 parameter sets, e.g., 4 or more, 8 or more, 16 or more, 32 or more, etc. The second parameter set 260 comprises a first private set of bivariate polynomials 262, and a second private set of reduction integers 264.

The embodiment below is described for two parameters sets: parameter set 250 and 260. It must be born in mind that in a typical embodiment the number of parameter sets will be higher, say 16 or even more. What is said below for two sets also applies to more than two sets.

There may be some overlap between parameter sets, e.g., they may have the same public reduction integer; or the same public reduction integer and the same set of reduction integers. In more secure embodiments, the parameter sets are different, e.g., generated independently. Preferably, the polynomials, i.e., first sets 252 and 262 are different in all parameter sets.

The public global reduction integer of a parameter set 256, 266, . . . is different from each of the reduction integers 254, 264 of that set. Preferably, the public global reduction integer of a parameter set 256, 266, . . . is larger than each of the reduction integers 254, 264 of that parameter set.

Key material obtainer 210 does not need interaction with a network device for obtaining the key material; in particular key material obtainer 210 does not need an identity number. System for configuring 200 may be a distributed system in which key material obtainer 210 is located at a different physical location than polynomial manipulation unit 220. Key material obtainer 210 generates all or part of the key material and/or obtains all or part of the key material from an external source. For example, key material obtainer 210 is suited to receive the public global reduction integers 256, 266 from an external source and generate the first private sets 252, 262 and second sets 254, 264. The latter allows all network devices to be manufactured with a fixed public global reduction integers 256, 266 reducing cost.

Key material obtainer 210 may comprise an electronic random number generator. The random number generator may be a true or pseudo random number generator. Key material obtainer 210 may generate a public global reduction integer, . . . , e.g., using the electronic random number generator. Although, the public global reduction integer is public information, introducing randomness makes analyzing the system more difficult.

With each bivariate polynomial in a first set, a reduction integer from a second set is associated. The random coefficients may be randomly selected from an integer ring, e.g., the integers modulo a number, such as the associated reduction integer.

Key material obtainer 210 may generate one or more coefficients of a reduction integer f_{″} in a second private set using the electronic random number generator. It is not necessary that the reduction integers are primes. However, they may be chosen as prime to increase resistance. Prime numbers give rise to fields, which is a species of rings. The same parameter sets, i.e., the same first and second private sets, and public global reduction numbers, are used for all network devices that later need to share a key.

Key material obtainer 210 may generate one or more coefficients of a bivariate polynomial \check{z}_{″}(,)) in a first private set 252, 262, e.g., using the electronic random number generator. Key material obtainer 210 may generate all of the bivariate polynomial in this fashion. Key material obtainer 210 may use a maximum degree of these polynomials, say 2, or 3 or higher, and generate one more random coefficient than the degree.

It is convenient to prescribe some aspects of first private sets 252, 262 such as the number of polynomials in private sets 252, 262 and the degrees of the polynomials, or the maximum degrees. It may also be prescribed that some of coefficients in the polynomials are zero, e.g., for reducing storage requirements.

A first set may contain two equal polynomials. This will work, however, unless the associated reduction integers are different the sets may be reduced in size. So typically, whenever two or more bivariate polynomials in the first set are the same, the associated reduction integers, i.e. the underlying ring, is different.

In an embodiment all first private sets of bivariate polynomials (\check{z}_{″}(,)) only comprises symmetric bivariate polynomials. Using only symmetric polynomials has the advantage that each network device can agree on a shared key with any other network device of the configured network devices. However, a first private set of bivariate polynomials may contain one or more asymmetric polynomials; this has the effect that the devices can be portioned into two groups: a device from one group can only agree on a shared key with a device of the second group.

Key material obtainer 210 is configured to obtain in electronic form a first private set of bivariate polynomials 252, also referred to as \check{z}_{″}(,) in formulas. The embodiment described below assumes that all bivariate polynomials in set 252 are symmetric. Generation of the second parameter set may be done in the same manner.

A symmetric bivariate polynomial may also be notated as \check{z}_{″}(, i) with two formal variables as placeholder. A symmetric bivariate polynomial satisfies \check{z}_{″}(, i)=\check{z}_{″}(i,). This requirement translates to a requirement on the coefficients, e.g., that the coefficient of a monomial ^{μ}i^{̂} equals the coefficient of a monomial ^{̂}i^{μ}.

The number of polynomials in first private set 252 may be chosen differently depending on the application. The system will work when the first and second set contain only a single polynomial; in such a system keys may be successfully shared and provide a moderate level of security. However, the security advantage of mixing over different rings is only achieved when the first set has at least 2 polynomials in them, and the second set has at least two different reduction integers.

Private set 252 comprises at least one bivariate polynomial. In an embodiment of initiating key-agreement device 100 the private set 252 consists of one polynomial. Having only one polynomial in private set 252 reduces complexity, storage requirements and increases speed. However, having only one polynomial in private set 252 is considered less secure than having two or more polynomials in private set 252 because such a one-polynomial system does not profit from additional mixing in the summation described below. However, key sharing will work correctly and are considered sufficiently secure for low-value and/or low-security applications.

In the remainder, we will assume that private set 252 comprises at least two symmetric bivariate polynomials. In an embodiment, at least two, or even all of the polynomials are different; this complicates analysis of the system considerably. It is not necessary though, private set 252 may comprise two equal polynomials and still benefit from mixing in the summation step if these two polynomials are evaluated over different rings. Note that different reduction integers define different rings. In an embodiment, private set 252 comprises at least two equal polynomials associated with different associated reduction integers. Having two or more equal polynomials in the first set reduces storage requirements. In an embodiment, the second set comprises at least two polynomials, and all polynomials in the second set are different.

The polynomials in private set 252 may be of different degrees. With the degree of a symmetric bivariate polynomial we will mean the degree of the polynomial in one of the two variables. For example, the degree of ^{\check{s}}ᵢ^{\check{s}}+2i+1 equals 2 because the degree in is 2. The polynomials may be chosen to have the same degree in each variable; if the polynomials in private set 252 are symmetric the degree will be the same in the other variable.

The degrees of polynomials in private set 252 may be chosen differently depending on the application. Private set 252 comprises at least one symmetric bivariate polynomial of degree 1 or higher. In an embodiment, private set 252 comprises only polynomials of degree 1. Having only linear polynomials in private set 252 reduces complexity, storage requirements and increases speed. However, having only degree one polynomials in private set 252 is considered less secure than having at least one polynomial of degree at least two in private set 252 because such a system is considerably more linear. Even so, if multiple polynomials in private set 252 are evaluated over different rings, then the resulting encryption is not linear even if all polynomials in private set 252 are. In an embodiment, private set 252 comprises at least one, preferably two, polynomials of degree 2 or higher. However, key generation, encryption and decryption will work correctly if only degree 1 polynomials are used, and are considered sufficiently secure for low-value and/or low-security applications.

Having one or more polynomials in private set 252 with degree 0 will not impact the system, so long as the polynomial(s) with higher degree provide sufficient security.

For a mid-security application, private set 252 may comprise, or even consist of, two symmetric bivariate polynomials of degree 2. For a higher security application, private set 252 may comprise or even consist of two symmetric bivariate polynomials, one of degree 2 and one of degree higher than 2, say 3. Increasing the number of polynomials and/or their degrees will further increase security at the cost of increased resource consumption.

Preferably, the reduction integers are selected so that the difference of any two reduction integers in the same set of reduction integers has a common divisor. In particular, common divisor may be 2^{̂}; or in words, the difference between any two reduction integers end in a least as many zero fs as the size of the small key that will be derived from this instance.

For example, one way to generate the reduction integers and the public global reduction integer is as follows.

1. First generate the public global reduction integer . . . . For example as a random integer of prescribed size,

2. For each reduction integer, generate an integer ‡_{″} and generate the reduction integer f_{″} as the difference f_{″}= . . . † ‡_{″}2^{̂}.

The public global reduction integer may be chosen to have (,+1) •+•bits or more, wherein , is the highest degree in a single variable of the bivariate polynomials in the first private set. In that case, the integers ‡_{″} may be chosen as ‡_{″}<2^{‰}.

Key material obtainer 210 may be programmed in software or in hardware or in a combination thereof. Key material obtainer 210 may share resources with polynomial manipulation unit 220 for polynomial manipulation.

Network device manager 230 is configured to obtain in electronic form an identity number 310, ¥ for network device 300. Network device manager 230 may receive the identity number from the network device. For example, network device manager 230 may comprise or make use of a communication unit for receiving the identity number over a network. For example, network device manager 230 may comprise an antenna for receiving the identity number as a wireless signal. The identity number may be represented as a number of bits, typically, the number of bits in the identity number • is at least as large as the number of bits in the shared key.

System 200 may use the same identity number for all parameter sets. However, it is also possible to use a different identity numbers for different parameters sets. In the latter case, network manager 230 obtains multiple identity numbers.

Polynomial manipulation unit 220 is configured to compute a univariate private key polynomial 229 for a parameter set and an identifying number ¥. Polynomial manipulation unit 220 is applied to each of the parameter sets of key material obtainer 210. In an embodiment, polynomial manipulation unit uses the same identifying number for at least two, or even for each of the parameter sets. In an embodiment, the polynomial manipulation unit uses a different identifying number of a network device for at least two, or even for all of the parameter sets. The univariate private key polynomials that are thus obtained and the corresponding public global reduction integers are part of the local key material that will be sent to the network device.

Polynomial manipulation unit 220 receives the data in a parameter set from key material obtainer 210 over connection 238. Below it is described how polynomial manipulation unit 220 determines a univariate private key polynomial from the first parameter set. The generation of a univariate private key polynomial from the other parameter set is done in the same manner.

Polynomial manipulation unit 220 may compute the univariate private key polynomial 229 as follows:

Univariate polynomials are obtained by substituting the identity integer Y into each of the polynomials in the first private set of the parameter set that is currently processed.

By substituting a value for only one variable of a bivariate polynomial, the bivariate polynomial reduces to a univariate polynomial. The resulting univariate polynomial is then reduced modulo the reduction integer associated with the bivariate polynomial in which the identity integer ¥ was substituted. The resulting set of univariate polynomials is summed, e.g., by adding the coefficients of equal powers of y in the polynomials. This may be obtained from the formula for [symbol] _{″}§ in: •¦§(^{..})= [symbol] —<\check{z}_{œ}(,¥)>a [symbol] =_{″} [symbol] _{″}§″

Suppose \check{z}_{″}(,i) is one of the bivariate polynomials in the first private set. The coefficients of this polynomial are taken from the ring IR ¶ap_{œ}. That is the coefficients of the polynomials in the first set are taken from an integer ring. For simplicity, the variables and i are used to represent the formal variables of the integers in the first set.

After substitution, polynomial manipulation unit 220 obtains \check{z}_{″}(¥,i). Polynomial manipulation unit 220 is further configured to reduce this term modulo f_{″}. Coefficients are reduced in the ring over which the system operates, e.g., Áₐ, e.g., by reducing mod f. Preferably, polynomial manipulation unit 220 brings the result into a canonical form, i.e., a predetermined standardized representation. A suitable canonical form is representation of the coefficient sorted by degrees of the monomials. Alternatively, the substitution may be for y.

To ensure that the identity numbers act, random f in the system a randomization step at point in the chain is advisable to ensure that lattice attacks do not simplify. Especially if the network devices are given identity numbers according to a particular order, e.g., serial numbers, such a randomization step is advisable. For example, a cryptographic hash, say, sha-256 may be applied to the identity number, the result being shortened to B bits.

Furthermore, identity numbers may be extended to more bits. For example, an identity number of • f bits may extended, e.g., by hashing and/or concatenation, to • bits, with •^{Â}<•. For example and identity number ¥ may be extended to Ã(¥) or to ¥∥Ã(¥); Ã denotes hashing and ∥ denotes concatenation. The concatenation is done at the LSB side. A highly non-linear hash, such as a cryptographic hash is preferred for this operation.

If the first set only contains symmetric polynomials, then substitution of the identity integer ¥ may be in either one of the two variables of the bivariate polynomial. However, if substitution is done in an asymmetric polynomial, more care is needed. For example polynomial manipulation unit 220 may be configured to obtain whether first network device 300 is in a first or second group. The first and second groups are associated with the first and second variable of the bivariate polynomials, respectively. For a network device in the first group always the first variable is used. For a network device in the second group always the second variable is used.

FIG. 1 shows one possible way to implement this function. FIG. 1 shows a substituting unit 222, a polynomial reduction unit 224, a polynomial addition unit 226 and a sum of a set of univariate polynomials 228; the latter will be univariate private key polynomial 229. These may work as follows. Substituting unit 222 substitutes the identity integer ¥ into a bivariate polynomial of the first set. Substituting unit 222 may collect terms to bring the result in canonical form, but this may also wait. Polynomial reduction unit 224 receives the result of the substitution and reduces it modulo the reduction integer associated with the bivariate polynomial in which was substituted.

The result of substituting the identity integer ¥ into said particular polynomial \check{z}_{″}(¥,i) and reducing modulo the reduction integer associated with said particular polynomial is represented as a list of coefficients in a canonical form before the summing by polynomial addition unit 226. The variable i acts as a formal variable. This substitution is sometime notated simply as: \check{z}_{″}(¥,).

Polynomial addition unit 226 receives the reduced univariate polynomials and adds them to a running total in sum 228. Sum 228 was reset to 0 prior to the generation of the univariate private key polynomial. Polynomial addition unit 226 may add the polynomials coefficient-wise, using either natural arithmetic or modulo the public global reduction number associated to the parameter set.

When all polynomials of the first private set are processed in this way, the result in sum 228 may be used as the univariate private key polynomial. The resulting univariate private key polynomial, say in sum 228, may be represented as a list of coefficients and in a canonical form.

If system 200 uses multiple instances, i.e., if system 200 uses multiple parameter sets, then polynomial manipulation unit 220 determines a univariate private key polynomial for each of them. If needed unit 220 may re-use some information, e.g., unit 220 may use the same identity number ¥ to generate all univariate private key polynomials. For more security the parameter sets are independent, and preferably also use a different identity number.

Network device manager 230 is further configured for electronically storing the generated univariate private key polynomials 229 and the corresponding public global reduction integers 256, . . . at the network device. Using the univariate private key polynomials 229 and its identity number or numbers, first network device 300 can share keys with other devices configured from the same root material. Network device manager 230 may also be configured for electronically storing the parameters B and b at the network device.

Although polynomial manipulation unit 220 may be implemented in software, polynomial manipulation unit 220 is particularly suited for implementation in hardware. If only polynomial reduction unit 224 is implementing hardware a significant speed improvement will be obtained; part of the functionality of system 200 that is not performed by a hardware version of the unit 224 may be performed in software running of a processor.

FIG. 1 shows polynomial manipulation unit 220 receiving an identity number message 232 from first network device 300; first network device 300 receiving a public global reduction integer message 234 from key material obtainer 210 and a univariate private key polynomial message 236 from polynomial manipulation unit 220. These messages typically are sent and received through network device manager 230. Univariate private key polynomial message 236 and public global reduction integer message 234 may be combined in a single message. The public global reduction integer message 234 may contain multiple public global reduction integers, corresponding to the multiple univariate private key polynomials in the univariate private key polynomial message 236. Identity number message 232 may contain one or multiple identity numbers. Identity number message 232 may also or instead contain one or more further identity numbers, system 200 being configured to derive one or more identity numbers from the one or more further identity numbers, e.g., by hashing them.

System for configuring 200 may be configured to obtain an identity number by generating an identity number for first network device 300. Such a configuration is well suited to a manufacturing facility. In that case first network device 300 receives identity number message 232 from configuration system 200, instead of sending it, say receive identity number message 232 from key material obtainer 210 or polynomial manipulation unit 220.

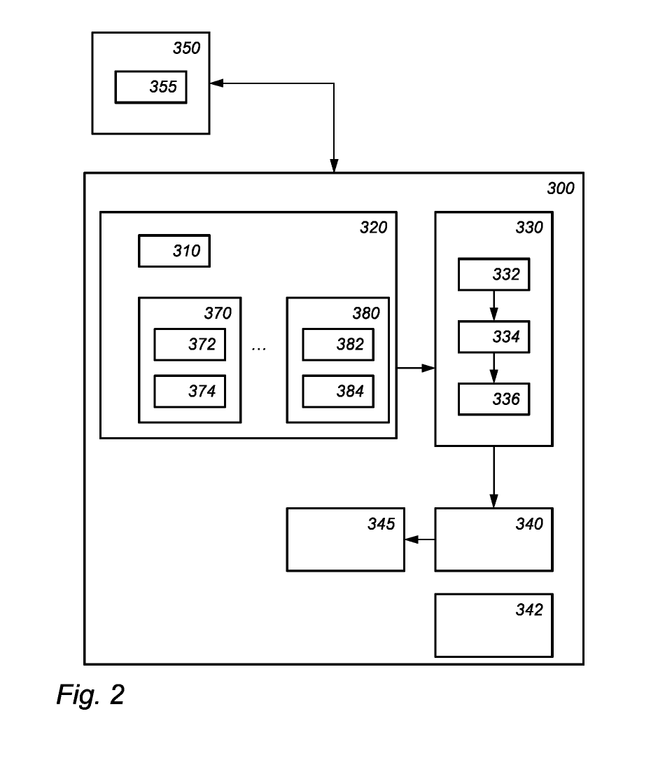

FIG. 2 is a schematic block diagram of a first network device 300 and a second network device 350. First network device 300 and second network device 350 are configured to determine a shared key together.

Second network device 350 may be of the same design as network device 300. We only describe first network device 300 in detail, second network device 350 may be the same or similar. FIG. 2 only shows that second network device 350 stores an identity number 355. The identity number 355 of second network device 350 is public and may be exchanged with network device 300 to share a key. Second network device 350 also needs local key material (not shown), in particular one or more univariate private key polynomial(s) corresponding to identity number 355.

First network device 300 comprises an electronic storage 320, a communication unit 342, a polynomial manipulation unit 330 and a key derivation device 340.

Storage 320 stores local key material of device 300. The device may be configured to work with a single instance of local key material, i.e., one univariate polynomial univariate private key polynomial and one public global reduction integer. In the embodiment shown in FIG. 2, the device 300 comprises multiple sets of key material, of which a first 370 and second 380 are shown. The number of sets of key material may be larger than 2, as the key material of device 300 may have been obtained from a system for configuring a network device for key sharing, such as system 200. Key material comprises a univariate private key polynomial and a public global reduction integer. For example, first key material 370 comprises univariate private key polynomial 372 and a public global reduction integer 374; and second key material 380 comprises a univariate private key polynomial 382 and a public global reduction integer 384. The public global reduction integer may be shared among some or all key material. However, the private key polynomials are preferably different in all sets.

Storage 320 also stores the identity number 310, ¥, that was used to generate the univariate private key polynomial in the key material. The key material may also comprise the identity number, especially in case a different identity number is used for each key material.

Storage 320 may be a memory, say a non-volatile and writable memory, such as flash memory. Storage 320 may be other types of storage, say magnetic storage such as a hard disk. Storage 320 may be write-once memory.

Communication unit 342 is configured to obtain the identity numbers 355 of second network device 350. Communication unit 342 may be implemented as a wired connection, say a Wi-Fi, Bluetooth or Zigbee connection. Communication unit 342 may be implemented with a connection over a data network, say the internet.

Polynomial manipulation unit 330 is configured to derive a small key shared with device 350 for each set of key material in storage 320. Device 350 has the same number of key materials as device 300. Device 300 may receive one or more identity numbers from device 350. Device 300 may also receive a further identity number and derive the identity numbers therefrom. Below it is described how polynomial manipulation unit 330 may derive a single shared key using first key material 370. Deriving small shared key for the other key material proceeds in the same fashion. Using multiple shared keys a larger shared key may be derived.

Polynomial manipulation unit 330 may comprise a substituting unit 332, and an integer reduction unit 334.

Polynomial manipulation unit 330 is configured to substitute the identity integer ¥ into the univariate private key polynomial 372 and reduce the result of the substitution modulo the public global reduction integer 374. Polynomial manipulation unit 330 may use similar hardware or software as substituting unit 222 and polynomial reduction unit 224. Note that first network device 300 does not have access to the first and second private set.

Optionally polynomial manipulation unit 330 comprises a key equalizer 336. It may happen that device 300 and device 350 do not arrive at the same shared small key. An application may chose to ignore this possibility. In doing so, some pairs of network devices may not be able to engage in encrypted and/or authenticated communication as they lack a common shared key. For some applications it is sufficient that only some pairs of network devices are secured, e.g., ad-hoc networks are an example of this. Devices 300 and 350 may also be configured with an optional key equalizer 336. In one of the two devices 300 and 350 the key equalizer 336 generates key confirmation data from the generated key and sends it to the other device; in the other device key equalizer 336 uses received key confirmation data to adapt the generated small key so that the shared small key derived in both devices is the same.

For example, the key equalizer 336 in device 300 obtains a pre-determined number of least significant bits of the generated small key as key confirmation data. For example, the pre-determined number c may be chosen as the smallest number such that 2^{3/4}\check{Z}1+2(3•+2,), wherein , is the degree of the polynomials in the first private set and the number of polynomials.

If equalizer 336 is used to adapt keys, it adapts the generated small key until it conforms to the key confirmation data, i.e., deriving key confirmation data from the adapted small key would give the same result as the received key confirmation data for that key. Adapting small keys may be done by adding a multiple of the public global reduction integer and reducing modulo 2^{̂}, i.e., •‰§+¼..mod 2̂. If the least significant bits are used as confirmation data, the equalizer adds multiples until the c least significant bits are the same as the received bits.

Key derivation device 340 is configured to derive the shared key from all the small keys, i.e., all the result of the reduction modulo the public global reduction integers. The shared key is a so-called symmetric key. The result of the reduction is an integer. This result may be used almost directly as a key, say by concatenating its coefficients optionally after equalization.

Deriving the shared key from the result of the reduction may include the application of a key derivation function, for example the function KDF, defined in the OMA DRM Specification of the Open Mobile Alliance (OMA-TS-DRM-DRM-V2_0_2-20080723-A, section 7.1.2 KDF) and similar functions.

Instead of sending and receiving key confirmation data per small key, the equalizer may also be configured to generate key confirmation data over the assembled large shared key, possibly even after a key confirmation algorithm like KDF. In this case, the equalizer adapts all small keys simultaneously until a large key is found that satisfies the key confirmation data. Although varying multiple small keys at the same is much more work, generating key confirmation data over the large key is also much more secure as less direct information is available for the small keys.

FIG. 2 further shows an optional cryptographic unit 345 in first network device 300. Cryptographic unit 345 is configured to use the shared key. For example, cryptographic unit 345 may be an encryption unit configured for encrypting an electronic message with the shared symmetric key. For example, cryptographic unit 345 may be a decryption unit configured for decryption an electronic message with the shared symmetric key.

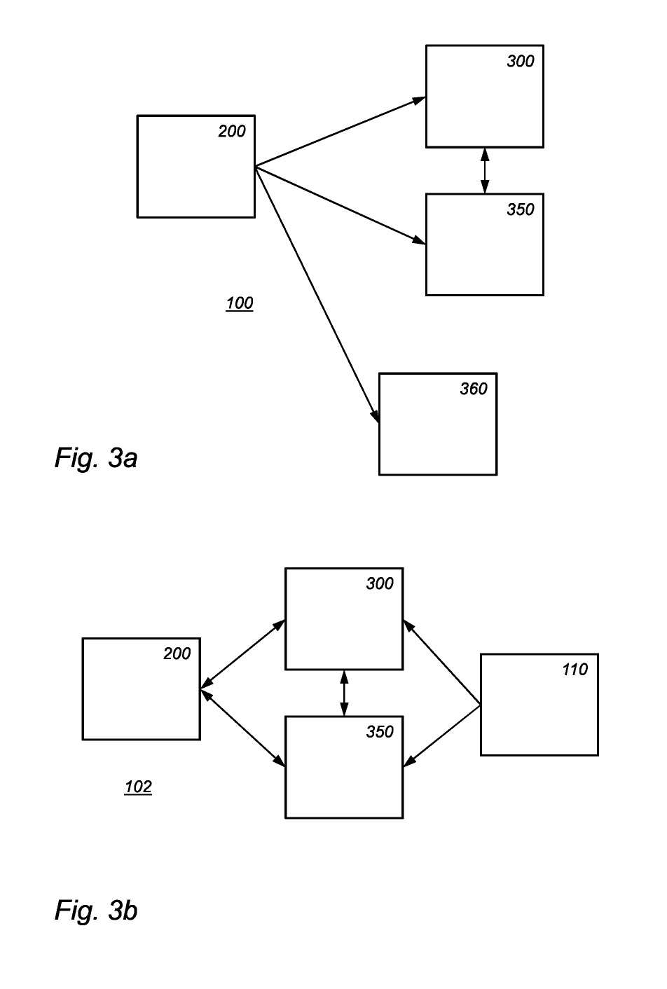

FIG. 3a is a schematic block diagram of a key sharing system 100.

Key sharing system 100 comprises system for configuring 200, and multiple network devices; shown are network device 300, 350 and 360. The network devices each receive identity numbers, univariate private key polynomials and the global reduction integers from system for configuring 200. Using this information they can agree on a shared key. For example, first network device 300 and second network device 350 each send their identity numbers to the other party. They can then compute multiple small shared keys, which they combine into a larger shared key. Someone with knowledge of the communication between first network device 300 and second network device 350 and even the global reduction integers cannot obtain their shared key, without using unreasonable large resources. Not even device 360 can derive the key shared between devices 300 and 350.

FIG. 3b is a schematic block diagram of a similar key sharing system 102. System 102 is the same as system 100 except that the network devices receive their identity numbers from a configuration server 110, also referred to as a personalization device. The network devices then register with system for configuring 200 by sending their identity number. Not even device 360 can obtain the key shared between devices 300 and 350.

The configuration server 110 may assign an identity number that is also used for other purposes. For example, configuration server 110 may assign a network address, such as a MAC address. The network address is used by the network node for routing network traffic from a second network node to itself. However, the network address may also double as the identity number. In this case, the network node makes its network address available to system 200 and receives a univariate private key polynomial which allows the network node to engage in encrypted communication using its network address as identity number. It is preferred that identity numbers have full entropy, i.e., B bits of entropy. However, when this cannot be realized, it is preferred to perform an entropy smoothing function, e.g., a hash function before using the number as the identity number.

The configuration server 110 may generate identity numbers to increase security of the system by avoiding identity numbers that are close, i.e., that share many or all of the most significant bits. For example, server 110 may generate the identity numbers randomly, say true or pseudo random. It is also sufficient to append predetermined number of random bits to an identity number, say 10 bits. The identity number may have the form ¥ [symbol] ∥¥_{\check{s}}, in which ¥_ is not random, say a serial number, network address, or the like, and wherein ¥_{\check{s}} is random. ¥_{\check{s}} may be generated by a random number generator. ¥_{\check{s}} may also be generated by hasing ¥_. If a keyed hash is used, say an HMAC, this then ¥_{\check{s}} is indistinguishable from random to parties without access to said key. The key may be generated and stored by server 110.

Server 110 may be included in system 200, e.g., incorporated in network manager 230.

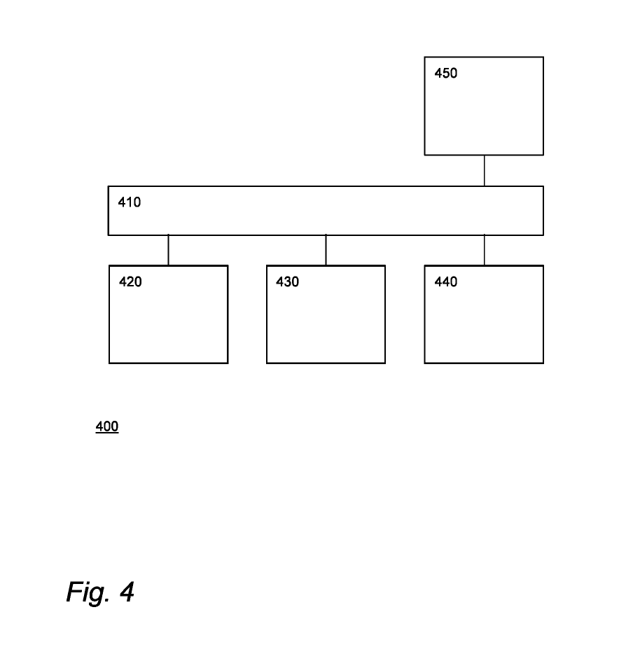

FIG. 4 is schematic block diagram of an integrated circuit 400. Integrated circuit 400 comprises a processor 420, a memory 430, and an I/O unit 440. These units of integrated circuit 400 can communicate amongst each other through an interconnect 410, such as a bus. Processor 420 is configured to execute software stored in memory 430 to execute a method as described herein. In this way integrated circuit 400 may be configured as system for configuring 200 or as a network device, such as first network device 300; Part of memory 430 may store public global reduction integers, first private sets of bivariate polynomials, second private sets of reduction integers, identity numbers, a plain message and/or encrypted message as required.

I/O unit 440 may be used to communicate with other devices such as devices 200, or 300, for example to receive key data, such as first private set of bivariate polynomials 252 and possibly associated parameters, such as sizes, degrees, moduli and the like, or to send and receive encrypted and/or authenticated messages. I/O unit 440 may comprise an antenna for wireless communication. I/O unit 440 may comprise an electric interface for wired communication.

Integrated circuit 400 may be integrated in a computer, mobile communication device, such as a mobile phone, etc. Integrated circuit 400 may also be integrated in lighting device, e.g., arranged with an LED device. For example, an integrated circuit 400 configured as a network device and arranged with lighting unit such as an LED, may receive commands encrypted with a shared symmetric key.

Multiple network devices, say incorporated in a lighting device, may form the nodes of an encrypted network, in which links are encrypted using shared keys between the nodes.

Although polynomial manipulation may be performed by processor 420 as instructed by polynomial manipulation software stored in memory 430, the tasks of key generation, and calculating the univariate polynomials are faster if integrated circuit 400 is configured with optional polynomial manipulation unit 450. In this embodiment, polynomial manipulation unit 450 is a hardware unit for executing substitution and reduction operations.

Typically, the devices 200, and 300 each comprise a microprocessor (not shown) which executes appropriate software stored at the device 200 and the 300; for example, that software may have been downloaded and/or stored in a corresponding memory, e.g., a volatile memory such as RAM or a non-volatile memory such as Flash (not shown). Alternatively, the devices 200 and 300 may, wholly or partially, be implemented in programmable logic, e.g., as field-programmable gate array (FPGA).

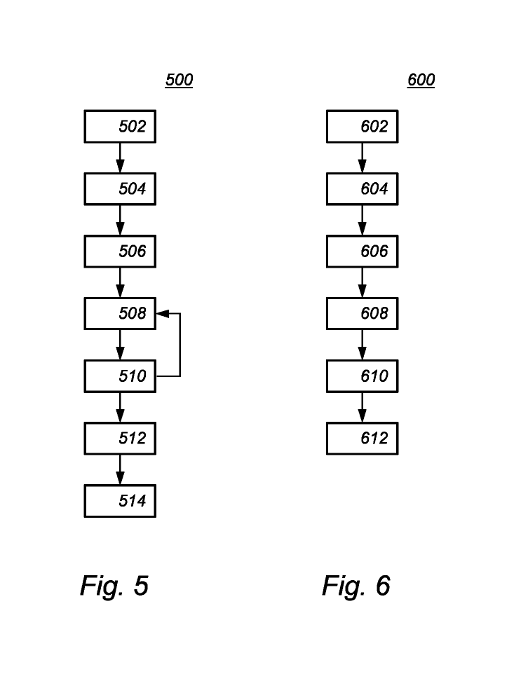

FIG. 5 shows a flowchart illustrating a method 500 for configuring a network device, say first network device 300, for sharing a key of • bits long. Method 500 comprises:

Obtaining 502 in electronic form a public global reduction integer 252, . . . , a first private set of bivariate polynomials 252, \check{z}_{″}(,), and a second private set of reduction integers 254. With each bivariate polynomial in the first set a reduction integer of the second set is associated. Step 502 may be part of obtaining key material.

Obtaining 504 in electronic form an identity number 310, ¥ for the network device, the identity number being • bits long, wherein •>•

Computing 506 a univariate private key polynomial 229 from the first and second private sets by

Obtaining a set of univariate polynomials by for each particular polynomial of the first private set, substituting 508 the identity number ¥ into said particular polynomial \check{z}_{″}(¥,) and reducing 510 modulo the reduction integer associated with said particular polynomial. Summing 512 the set of univariate polynomials, e.g., by adding the coefficients of equal powers of the remaining formal variable.

Storing 514 the generated univariate private key polynomial 229 and the public global reduction polynomial 252, . . . at the network device.

FIG. 6 show a flowchart illustrating a method 600 determining a shared key of size • with a second network device 350. Method 600 comprises:

Storing 602 a univariate private key polynomial 372 and a public global reduction integer 374, . . . obtained from a system for configuring a network device for key sharing as described herein.

Storing 604 an identity number 310, ¥ for the first network device, the first identity number being • bits long, wherein •>•,

Obtaining 606 an identity number 355 for the second network device the identity number 355 for the second network device being • bits long, wherein •>•,

Substituting 608 the second identity integer into the univariate private polynomial and reducing 610 the result of the substituting modulo the public global reduction integer ( . . . ), further reducing the result of the reduction modulo the public global reduction integer ( . . . ) modulo 2^{̂}.

Deriving 612 the shared key from the result of the reduction modulo 2^{̂}.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. Moreover, a given step may not have finished completely before a next step is started.

A method according to the invention may be executed using software, which comprises instructions for causing a processor system to perform method 500 and/or 600. Software may only include those steps taken by a particular sub-entity of the system. The software may be stored in a suitable storage medium, such as a hard disk, a floppy, a memory etc. The software may be sent as a signal along a wire, or wireless, or using a data network, e.g., the Internet. The software may be made available for download and/or for remote usage on a server.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

### LIST OF REFERENCE NUMERALS IN FIGS. 1-4

100,102 a key sharing system
110 a personalization device
200 a system for configuring a network device for key sharing
210 a key material obtainer
220 a polynomial manipulation unit
222 a substituting unit
224 a polynomial reduction unit
226 a polynomial addition unit
228 sum of a set of univariate polynomials
229 univariate private key polynomial
230 a network device manager
232 an identity number message
234 a public global reduction integer message
236 a univariate private key polynomial message
250 a first parameter set
252 a first private set of bivariate polynomials
254 a second private set of reduction integers
256 a public global reduction integer
260 a second parameter set
262 a first private set of bivariate polynomials
264 a second private set of reduction integers
266 a public global reduction integer
300 a first network device
310 an identity number
320 an electronic storage
330 a polynomial manipulation unit
332 a substituting unit
334 an integer reduction unit
336 a key equalizer
340 a key derivation device
342 a communication unit
345 a cryptographic unit
350 a second network device
355 an identity number
360 a third network device
370 a first key material
372 a univariate private key polynomial
374 a public global reduction integer
380 a second key material
382 a univariate private key polynomial
384 a public global reduction integer
400 an integrated circuit
410 an interconnect
420 a processor
430 a memory
440 an I/O unit
450 a polynomial manipulation unit

1.-15. (canceled)

16. A system for configuring a network device for sharing a shared key to obtain a combined key, the shared key being b bits long, the system comprising:
a key material obtainer for
obtaining in electronic form a first private set of bivariate polynomials (252, fᵢ(,)), and a second private set of reduction integers (254, pᵢ), with each bivariate polynomial in the first set there is associated a reduction integer of the second set, and a public global reduction integer (256, N), the public global reduction integer having at least (α+1)B+b bits, wherein α is the highest degree in a single variable of the bivariate polynomials in the first private set, each private reduction integer satisfying pᵢ=N−βᵢ2^{b}, for some integer βᵢ<2^{B},
a network device manager for obtaining in electronic form an identity number (310, A) for the network device, the identity number being B bits long, wherein B>b, and
a polynomial manipulation unit for computing for the network device a univariate private key polynomial from the first and second private sets by
obtaining a set of univariate polynomials by
for each particular polynomial of the first private set, substituting the identity number (A) into said particular polynomial fᵢ (A,) and reducing modulo the reduction integer associated with said particular polynomial, and
summing the set of univariate polynomials,
the network device manager being further configured for electronically storing the generated univariate private key polynomial and the public global reduction integer (256, N) at the network device,
wherein the combined key is derived from multiple shared keys.

17. A system as in claim 16, wherein B is a multiple of b.

18. A system as in claim 16, for configuring a network device for sharing a shared key to obtain a combined key, wherein the key material obtainer is configured to obtain multiple first private sets of bivariate polynomials (252, fᵢ(,)), with each bivariate polynomial in a first set of the multiple first sets there is associated a reduction integer of a second private set,
the polynomial manipulation unit is configured to compute multiple univariate private key polynomials from the multiple first private sets, by
for each first private set of the multiple private sets
obtaining a set of univariate polynomials by
for each particular polynomial of said first private set, substituting an identity number (A) into said particular polynomial fᵢ(Aᵢ) and reducing modulo a reduction integer associated with said particular polynomial, and
summing the set of univariate polynomials,
the network device manager being further configured for electronically storing the multiple generated univariate private key polynomials at the network device.

19. A system as in claim 16, for configuring a network device for sharing a shared key to obtain a combined key, wherein the key material obtainer is configured to obtain multiple second private sets of reduction integers (254, Pᵢ)), with each first set of the multiple first sets there is associated a second set of the multiple second sets, with each bivariate polynomial in a first set of the multiple first sets there is associated a reduction integer of an associated second set of the multiple second sets.
the polynomial manipulation unit being configured for reducing modulo a reduction integer associated with said particular polynomial from a second set associated with said first set.

20. A system as in claim 16, for configuring a network device for sharing a shared key to obtain a combined key, wherein the key material obtainer is configured to obtain in electronic form multiple public global reduction integers (256, N), with each first set of the multiple first sets there is associated a public global reduction integer of the multiple public global reduction integers, the network manager being further configured for electronically storing the multiple generated public global reduction integers at the network device.

21. A first network device configured to determine a shared combined key with a second network device, the combined key being derived from multiple shared keys, the shared keys being b bits long, the first network device comprising
an electronic storage storing a univariate private key polynomial and a public global reduction integer (374, N) obtained from a system for configuring a network device for key sharing as in claim 16, the storage further storing a first identity number (310, A) for the first network device used to generate the univariate private key polynomial, the first identity number being B bits long, wherein B>b,
a communication unit for obtaining a second identity number of the second network device, the second identity number being B bits long, wherein B>b, the second network device being different from the first network device,
a polynomial manipulation unit for
substituting the second identity integer into the univariate private key polynomial,
reducing the result of the substituting modulo the public global reduction integer (N), and
further reducing the result of the reducing modulo the public global reduction integer (N) modulo 2^{b}.

22. A first network device as in claim 21, wherein
the electronic storage is configured to store multiple univariate private key polynomials;
a polynomial manipulation unit configured to
obtain multiple small shared keys from the multiple univariate private key polynomials, by for each univariate private key polynomial in the multiple univariate private key polynomials,
substituting a second identity integer into the univariate private key polynomial,
reducing the result of the substituting modulo a public global reduction integer (N), and
further reducing the result of the reducing modulo the public global reduction integer (N) modulo 2^{b},
a key derivation device for deriving the combined shared key from the multiple small shared keys.

23. A first network device as in claim 22 wherein
the electronic storage is configured to store multiple public global reduction integers (374, N), with each univariate private key polynomial of the multiple univariate private key polynomials there is associated a public global reduction integer of the multiple public global reduction integers,
the polynomial manipulation unit is configured for
reducing the result of the substituting modulo the public global reduction integer (N) associated to the univariate private key polynomial.

24. A first network device as in claim 22, wherein
the electronic storage stores multiple identity numbers for the first network device,
a communication unit is configured for obtaining multiple identity number of the second network device, with each univariate private key polynomials of the multiple univariate private key polynomials there is associated an identity number of the multiple identity numbers
the polynomial manipulation unit is configured to
obtain multiple small shared keys from the multiple univariate private key polynomials by for each univariate private key polynomial in the multiple univariate private, key polynomials
generating a small shared key of size the key size being smaller than the size of the identity number associated with said univariate private key polynomial (bᵢ<Bᵢ),
substituting said identity integer into said univariate private key polynomial,
reducing the result of the substituting modulo a public global reduction integer (N), and
further reducing the result of the reducing modulo the public global reduction integer (N) modulo 2^{b}^{ᵢ}.

25. A first network device as in claim 22, comprising
a key equalizer configured to
compute key confirmation data for a shared key and send the key confirmation data to the second network device, and/or to
receive key confirmation data from the second network device and to adapt a small key to conform to the received key confirmation data.

26. A key sharing system comprising a system for configuring a network device for key sharing as in claim 16, and a first and second network device configured by the system for configuring a network device for key sharing.

27. A method for configuring a network device for sharing a shared key to obtain a combined key, the method comprising:
obtaining in electronic form a public global reduction integer (256, N), a first private set of bivariate polynomials (252, fᵢ(,)), and a second private set of reduction integers (254, pᵢ), with each bivariate polynomial in the first set there is associated a reduction integer of the second set, the public global reduction integer having at least (α+1)B+b bits, wherein α is the highest degree in a single variable of the bivariate polynomials in the first private set, each private reduction integer satisfying pᵢ=N−βᵢ2^{b}, for some integer βᵢ with βᵢ<2^{B},
obtaining in electronic form an identity number (310, A) for the network device, the identity number being B bits long, wherein B>b,—computing a univariate private key polynomial) from the first and second private sets by
obtaining a set of univariate polynomials by
for each particular polynomial of the first private set, substituting the identity integer (A) into said particular polynomial fᵢ(A,) and reducing modulo the reduction integer associated with said particular polynomial, and
summing the set of univariate polynomials,
storing the generated univariate private key polynomialand the public global reduction integer (256, N) at the network device
deriving the combined key from multiple shared keys.

28. A method for determining a shared combined key with a second network device, the method comprising
deriving the combined key from multiple shared keys of size b, and
determining a shared key of size b by:
storing a univariate private key polynomial and a public global reduction integer (374, N)

16. from a system for configuring a network device for key sharing as in claim 16,
storing a first identity number (310, A) for the first network device, the first identity number being B bits long, wherein B>b,
obtaining a second identity number of the second network device, the second identity number being B bits long, wherein B>b, and
substituting the second identity integer into the univariate private polynomial and reducing the result of the substituting modulo the public global reduction integer (N), further reducing the result of the reducing modulo the public global reduction integer (N) modulo 2^{b}.

29. A computer program embodied on a computer readable medium, comprising computer program code means adapted to perform all the steps of claim 27 when the computer program is run on a computer.
